(19) United States
(12) Patent Application Publication
(10) Pub. No.: US 2013/0167824 A1
(43) Pub. Date: Jul. 4, 2013

(54) BARBECUE GRILL

(71) Applicant: Mel CALINAWAN, Salinas, CA (US)

(72) Inventor: Mel CALINAWAN, Salinas, CA (US)

(21) Appl. No.: 13/728,872

(22) Filed: Dec. 27, 2012

Related U.S. Application Data
(60) Provisional application No. 61/581,426, filed on Dec. 29, 2011.

(51) Int. Cl. A47J 37/07

(52) U.S. Cl. CPC A47J 37/07
USPC 126/25 R

(57) ABSTRACT

The barbecue grill includes an adjustably louvered cooking surface to regulate cooking heat for food placed thereon. The louvers may be independently adjustable to allow cooked food to be placed atop closed louvers to reduce the heat distributed thereto, while other louvers remain open to continue cooking food placed thereon. The fire pan includes a cruciform tubular aerator to provide greater air flow for the fuel burning in the pan. An optional removable grill of wire rod or other structure may be placed atop the louver assembly. The louvered cooking surface, aerator, and/or optional grill may be formed of corrosion-resistant steel for greater longevity. Both the louvered cooking surface and the aerator are preferably removable from the fire pan to facilitate cleanup. The adjustable louver assembly and tubular aerator may be applied to barbecues having shapes and configurations other than generally rectangular.

### CROSS-REFERENCE TO RELATED APPLICATION

This application claims the benefit of U.S. Provisional Patent Application Ser. No. 61/581,426, filed Dec. 29, 2011.

### BACKGROUND OF THE INVENTION

1. Field of the Invention

The present invention relates to cooking apparatus, and particularly to a barbecue grill having a plurality of adjustable louvers in the cooking surface and aeration tubes in the fire pan.

2. Description of the Related Art

While portable and/or outdoor cooking devices and systems were once required for any form of cooking, the development of indoor electric and gas cooking appliances has essentially eliminated the need for outdoor cooking. As a result, portable barbecues for outdoor use are presently used more for recreational cooking than as essential devices for the preparation of meals. Accordingly, they tend to be relatively simple devices comprising little more than a fire pan and a grill, particularly in their small and portable variations.

However, it can prove to be quite difficult, and in some cases impossible, to achieve the desired results using such relatively simple and primitive barbecue grills or other simple portable outdoor cooking appliances and devices. For example, it can be quite difficult or even impossible to keep cooked food warm on a simple grill, without overcooking or burning the food. Another related consideration is the regulation of the combustion of the fuel being used, e.g., charcoal in most cases. While it is generally easier to produce heat for cooking over a relatively prolonged period of time by using charcoal as the fuel, some form of regulation of the rate of combustion is nevertheless required for optimum heat output and resulting cooking efficiency with charcoal or any other fuel.

Thus, a barbecue grill solving the aforementioned problems is desired.

### SUMMARY OF THE INVENTION

The barbecue grill includes a plurality of adjustable louvers for the cooking surface thereof, and an aerator installed in the fire pan for supplying and regulating the air flow to the fuel being combusted in the fire pan. The various louvers are preferably independently adjustable to allow the cook to open and close various louvers or groups of adjacent louvers independently of one another. This allows the cook to close off certain louvers to reduce the heat flowing therethrough from the underlying burning fuel, thereby allowing food placed upon the closed louvers to remain warm without overcooking. Other louvers may remain open to allow more heat to flow therethrough, thereby continuing the cooking of food placed over such opened louvers. The positions of the louvers may be regulated or adjusted to any degree between fully opened and completely closed, as desired. The louvers form a substantially flat surface when completely closed.

Regulation of combustion of the cooking fuel is achieved by perforated aerator tubes extending through the base of the fire pan of the grill assembly. The aerator tubes preferably comprise a cruciform shape, and the distal ends of the tubes abut the interior walls of the fire pan. At least one air opening and adjustable air shutter are provided in one wall of the fire pan. The opening communicates with one of the distal ends of the cruciform aerator tubes. This allows the air flow to be adjusted through the aerator tubes, thus adjusting the air flow through the tubes and their perforations to the charcoal or other combustible fuel in the fire pan to adjust the heat output of the fuel.

The term “barbecue grill” as used herein is intended broadly to encompass the fire pan, louver assembly, aerator, support structure, handles (if any), and/or other accessories provided and/or used therewith. The barbecue grill may comprise the exemplary, generally rectangular structure having relatively short support legs as illustrated in FIGS. 1 and 2 for use, e.g., as a tabletop unit, or may alternatively comprise a free-standing unit of rectangular, circular, or other shape. The barbecue grill may include either or both of the adjustable louvers and aerator tubes. An optional grill of wire rod or other structure may also be provided to rest atop the louvers or the edges of the fire pan. The adjustable louver assembly and/or the aerator tubes are preferably formed of corrosion-resistant steel, i.e., “stainless steel,” to reduce or obviate corrosion of these various metal components. The optional grill may be formed of corrosion-resistant steel as well.

These and other features of the present invention will become readily apparent upon further review of the following specification and drawings.

### BRIEF DESCRIPTION OF THE DRAWINGS

FIG. 1 is a top and side perspective view of a barbecue grill according to the present invention, illustrating the adjustable louvers of the cooking surface.

FIG. 2 is an exploded perspective view of the barbecue grill according to the present invention, illustrating additional features thereof.

Similar reference characters denote corresponding features consistently throughout the attached drawings.

### DETAILED DESCRIPTION OF THE PREFERRED EMBODIMENTS

The barbecue grill provides better control of cooking temperatures for foods placed thereon than is achievable by conventional barbecues. This is accomplished by two components provided with the grill. The first is a cooking surface having a plurality of adjustable louvers, and the second is a tubular aerator system installed in the base of the fire pan of the grill assembly.

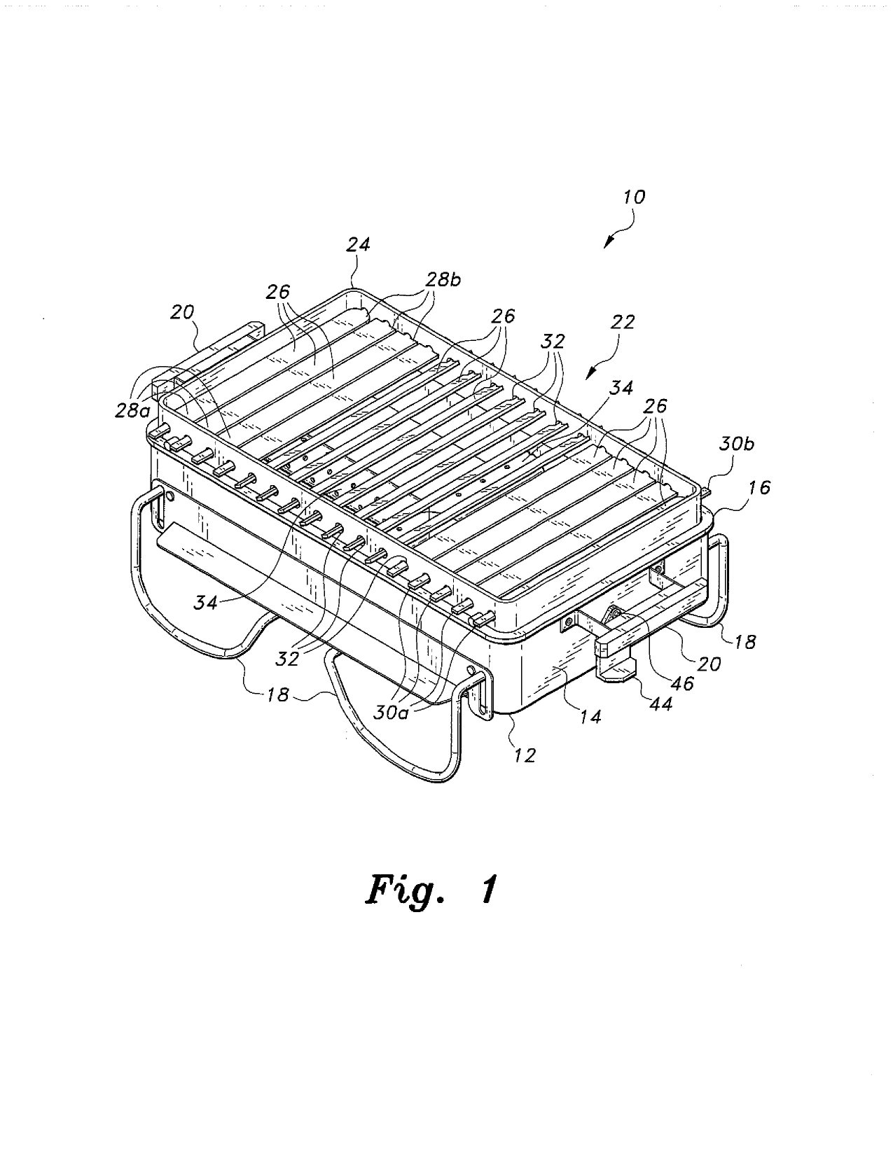

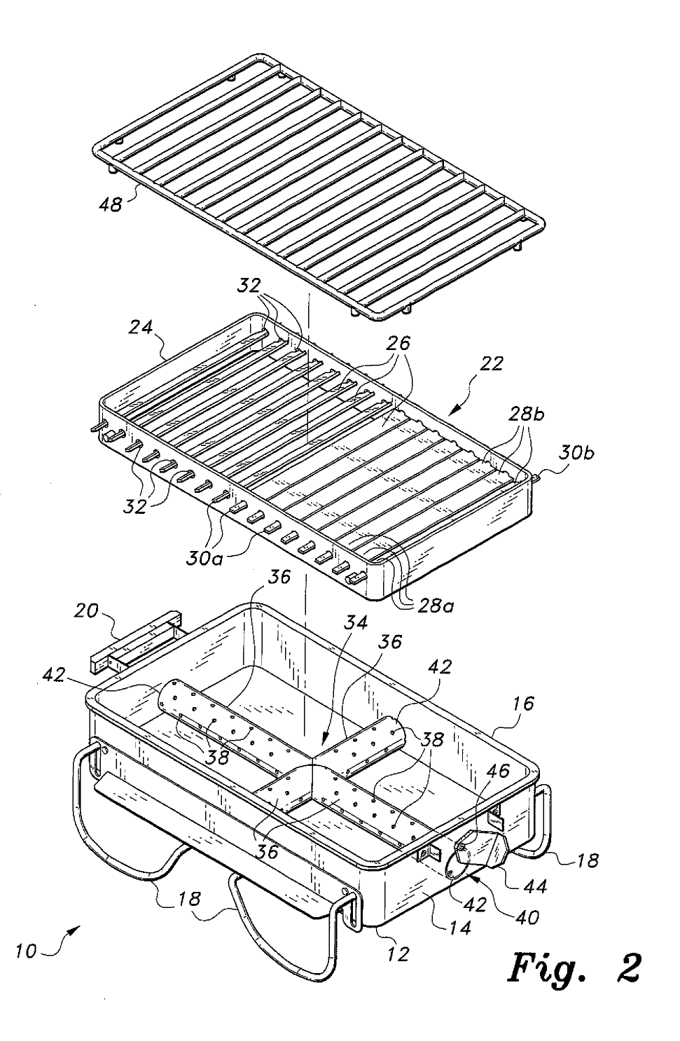

FIG. 1 of the drawings provides a top perspective view of an exemplary barbecue grill assembly 10 incorporating the adjustable louver cooking surface and aerator system, the aerator system being partially visible beneath the louvers of the cooking surface. The barbecue grill assembly 10 includes a fire pan 12 having a peripheral wall 14, the wall 14 having an upper peripheral rim 16. The assembly 10 preferably includes a support structure, e.g., legs 18, and may also include handles. (One of the handles 20 is omitted in FIG. 2, in order to show other features of the assembly.) The barbecue grill assembly 10 illustrated in FIGS. 1 and 2 is a relatively small tabletop unit, but it will be seen that the louvered cooking surface and aerator assembly may be adapted to barbecues having other configurations, e.g., free standing units having longer support legs and fire pans of circular or other shapes.

A cooking surface 22 rests removably atop the rim 16 of the fire pan wall 14. The cooking surface has a frame 24 supporting a plurality of adjustable louvers 26 therein. The cooking surface frame 24 is preferably configured to be substantially contiguous with the rim 16 of the fire pan wall 14 when placed thereon. Each of the louvers 26 has mutually opposed first and second ends 28a and 28b, each of the ends 28a, 28b having a louver support arm 30a, 30b, extending therefrom. (Only a single one of the arms 30b is visible in FIGS. 1 and 2, but the cooking surface 22 and its various components are laterally symmetrical.) The frame 24 includes a plurality of louver support arm passages 32 formed therethrough. The louver support arms 20a and 30b of the louvers 26 are pivotally captured within and supported by corresponding support arm passages 32 in the frame 24.

This allows each of the louvers 26 to be pivotally adjusted to allow heat to rise therebetween from the underlying burning cooking fuel, or to close off the heat from the burning fuel. In the exemplary cooking surface 22 of FIG. 1, it will be seen that the louvers 26 at each end of the cooking surface are closed, i.e., forming a substantially continuous horizontal plane, while the louvers 26 in the general center area of the cooking surface have been rotated or pivoted to slightly more open positions. This allows food placed atop the central area of the cooking surface 22 to receive more heat as it flows convectively between the open louvers 26, thereby cooking the food. When the food has been cooked to taste, it may be moved toward one end or the other of the cooking surface to be placed atop the closed louvers 26. The closed louvers block the convective heat flow from the fire pan 12. The heat-conductive nature of the metal (preferably corrosion-resistant or “stainless” steel, although other metals may be used, if desired) used to form the louvers 26 results in a fair amount of heat radiating through the closed louvers, but the convective heat flow is greatly reduced or blocked by the closed louvers 26. This results in food being placed atop the closed louvers 26 receiving sufficient heat to remain warm, but without receiving so much heat that it continues to cook and/or is burned. The various louvers 26 are preferably independently adjustable, as shown in FIGS. 1 and 2, but it will be seen that a conventional mechanical linkage (not shown) may be connected to the louver support arms 30a and/or 30b to rotate all of the louvers 26, or groups of the louvers, simultaneously, if desired.

An aerator 34 is installed within the fire pan 12. The aerator 34 is shown in both FIGS. 1 and 2 of the drawings, with FIG. 2 providing the better view of the aerator disposed within the fire pan 12. The aerator 34 comprises a plurality of hollow tubes 36 arranged in a cruciform pattern. Each of the tubes has a plurality of perforations 38 through the walls thereof. The peripheral wall 14 of the fire pan 12 preferably includes at least one airflow passage 40 therethrough, but more airflow passages may be provided, if desired. The distal ends 42 of the aerator tubes 36 are open, the aerator 34 being configured so that the open distal end 42 of at least one of the tubes 36 is at least generally aligned with the airflow passage 40 through the fire pan wall 14, thereby providing fluid communication between the ambient air and the interiors of the aerator tubes 36, and thus to the interior of the fire pan 12 by means of the perforations 38 of the tubes 36.

An airflow shutter 44 may be provided for the airflow passage 40 of the fire pan wall 14. The airflow shutter 44 may be adjustably attached to the fire pan wall 14 using any conventional means, e.g., the pivot bolt 46 illustrated, or a laterally slider or other arrangement. This allows the shutter 44 to be adjusted to allow more or less airflow into the aerator 34, and thus into the fuel (charcoal, etc., not shown) burning in the fire pan 12 and generally surrounding the aerator 34. Opening the shutter 44 allows more air to flow into the aerator tubes 36 and outward through their perforations 38, thereby feeding the fire with more oxygen for greater combustion. It will be seen that airflow passages 40 and corresponding airflow control shutters 44 may be provided at various locations through the fire pan wall 14 in order to control airflow into the aerator tubes 36 or directly into the fire pan 12.

The cooking surface 22 is not attached to the underlying fire pan 12, but merely rests removably atop the fire pan 12, as noted further above. Similarly, the aerator assembly 34 need not be fastened or secured in the fire pan 12, but may merely rest in the base of the fire pan. In this manner, these components may be removed to facilitate their cleaning, and also to facilitate the cleaning of the fire pan 12. In addition to the cooking surface 22 and aerator 34 assemblies, the barbecue grill apparatus or assembly 10 may include a conventional open grill or rack 48 for removable placement atop the cooking surface 22. The open grill or rack 48 may be formed of welded wire or rod in a conventional manner, or constructed in some other manner (e.g., cast, stamped sheet metal, etc.). While the cooking surface 22 and the adjustable louvers 26 serve to separate and distance the food from the underlying coals, it may be desired at times to provide additional separation of the food from direct contact with the louvers 26 of the cooking surface 22. The removable open grill or rack 48 serves this purpose.

It is preferred that at least some of the various removable components of the barbecue grill assembly 10 be formed of a durable, corrosion-resistant metal, such as “stainless” steel, for greater longevity and ease of cleanup. The open grill or rack 48 may also be formed of corrosion-resistant steel. However, other metals may be used if greater economy is desired. The fire pan 12 may be formed of conventional mild steel, but it may also be formed (stamped, etc.) of corrosion-resistant steel for greater longevity, if desired. Accordingly, the barbecue grill 10 and its adjustably louvered cooking surface 22 and cruciform aerator tube assembly 34 greatly improve the ability of the cook to control the heat output of the grill 10, thereby greatly refining the quality of the food(s) cooked on the grill.

It is to be understood that the present invention is not limited to the embodiments described above, but encompasses any and all embodiments within the scope of the following claims.

I claim:

1. A barbecue grill, comprising:
a fire pan;
an aerator disposed within the fire pan; and
a cooking surface disposed atop the fire pan, the cooking surface having a plurality of adjustable louvers, the louvers being selectively and continuously adjustable between a substantially completely closed position and an open position.

2. The barbecue grill according to claim 1, wherein said fire pan has a periphery, said cooking surface having a peripheral frame substantially contiguous with the periphery of the fire pan when placed thereon, said louvers being pivotally mounted in the frame, each of the louvers having a louver support arm extending from the frame for selectively and independently pivoting the louvers to any position between completely closed and completely open.

3. The barbecue grill according to claim 1, wherein said aerator comprises at least a pair of hollow perforated tubes configured in a cruciform shape.

4. The barbecue grill according to claim 3, wherein:
said fire pan has a peripheral wall having at least one airflow passage defined therein and an airflow control shutter selectively and adjustably disposed over the airflow passage; and
each of the hollow perforated tubes of the aerator has an open distal end, at least one of the open distal ends communicating fluidly with the at least one airflow passage of the wall of the fire pan.

5. The barbecue grill according to claim 1, further comprising an open grill removably disposed atop the cooking surface.

6. The barbecue grill according to claim 1, wherein said cooking surface is removably disposed on the fire pan.

7. The barbecue grill according to claim 1, wherein said aerator is removably disposed on the fire pan.

8. A barbecue grill, comprising:
a fire pan having a periphery;
a cooking surface disposed atop the fire pan, the cooking surface having:
a peripheral frame substantially contiguous with the periphery of the fire pan when placed thereon, the frame having a plurality of louver support arm passages disposed therethrough; and
a plurality of louvers disposed within the frame, each of the louvers having mutually opposed first and second ends, each of the ends having a louver support arm extending therefrom, each of the support arms extending through a corresponding one of the louver support arm passages of the frame, the louvers being selectively pivotal within the frame between a substantially completely closed position and an open position.

9. The barbecue grill according to claim 8, further comprising an aerator having at least a pair of hollow perforated tubes configured in a cruciform shape.

10. The barbecue grill according to claim 9, wherein:
said fire pan has a peripheral wall having at least one airflow passage defined therein and an airflow control shutter selectively and adjustably disposed over the airflow passage; and
each of the hollow perforated tubes of the aerator has an open distal end, at least one of the open distal ends communicating fluidly with the at least one airflow passage of the wall of the fire pan.

11. The barbecue grill according to claim 9, wherein said aerator is removably disposed on the fire pan.

12. The barbecue grill according to claim 8, wherein said cooking surface is removably disposed on the fire pan.

13. The barbecue grill according to claim 8, further comprising an open grill removably disposed atop the cooking surface.

14. A barbecue grill, comprising:
a fire pan;
an aerator disposed within the fire pan, the aerator having at least a pair of hollow perforated tubes configured in a cruciform shape; and
a cooking surface having a plurality of adjustable louvers, the louvers being selectively adjustable between a substantially completely closed position and an open position, the cooking surface being disposed atop the fire pan.

15. The barbecue grill according to claim 14, wherein said fire pan has a periphery, said cooking surface having a peripheral frame substantially contiguous with the periphery of the fire pan when placed thereon, said louvers being pivotally mounted in the frame, each of the louvers having a louver support arm extending from the frame for selectively and independently pivoting the louvers to any position between completely closed and completely open.

16. The barbecue grill according to claim 14, wherein:
said fire pan has a peripheral wall having at least one airflow passage defined therein and an airflow control shutter selectively and adjustably disposed over the airflow passage; and
each of the hollow perforated tubes of the aerator has an open distal end, at least one of the open distal ends communicating fluidly with the at least one airflow passage of the wall of the fire pan.

17. The barbecue grill according to claim 14, further comprising an open grill removably disposed atop the cooking surface.

18. The barbecue grill according to claim 14, wherein said cooking surface is formed of corrosion-resistant steel.

19. The barbecue grill according to claim 14, wherein said aerator is formed of corrosion-resistant steel.
